(19) United States
(12) Patent Application Publication
(10) Pub. No.: US 2017/0219384 A1
(43) Pub. Date: Aug. 3, 2017

(54) ANGLE TRANSMITTER UNIT FOR AN INDUCTIVE ANGLE SENSOR HAVING A REFERENCE RESONANT CIRCUIT (AS AMENDED)

(71) Applicant: Stephan Brüggemann, (US)

(72) Inventor: Stephan Brüggemann, (US)

(21) Appl. No.: 15/315,548

(22) PCT Filed: Jun. 30, 2015
(86) PCT No.: PCT/EP2015/064783

§ 371 Date: Dec. 1, 2016

(51) Int. Cl. G01D 5/20

(52) U.S. Cl. CPC G01D 5/204

(57) ABSTRACT

An angle transmitter unit for an inductive sensor for sensing detecting the position of a rotating element, the angle transmitter unit being connectible to a rotating element, having at least one first resonant circuit, interacting with at least one receiver coil of the sensor in order to provide the angle of the rotating element. The angle transmitter unit includes, in addition to the first resonant circuit, at least one additional, clearly-identifiable reference resonant circuit in order to form a reference position on the angle transmitter unit.

### CROSS REFERENCE TO RELATED APPLICATIONS

This application is the U.S. National Phase Application of PCT International Application No. PCT/EP2015/064783, filed Jun. 30, 2015, which claims priority to German Patent Application No. 10 2014 212 971.0, filed Jul. 3, 2014, the contents of such application being incorporated by reference herein.

### FIELD OF THE INVENTION

The invention relates to an angle transmitter unit for an inductive sensor for sensing the position of a rotating element and to a sensor for sensing the position of a rotating element.

### BACKGROUND OF THE INVENTION

EP 1 828 722 B1, the contents of such application being incorporated by reference herein discloses an inductive position detector having a first inductive device and a second inductive device, wherein the first inductive device comprises a passive resonant circuit and the second inductive device defines the measuring section and comprises at least two reception turns. The second inductive device is configured such that, during use, it induces an alternating current in the passive resonant circuit, so that the alternating current induced in the passive resonant circuit induces an alternating signal in each reception turn owing to the reciprocal inductance between the reception turns and the passive resonant circuit, these signals denoting the position of the first inductive device on the measuring section.

Further embodiments of inductive sensors are known from the applications DE 10 2013 225 918.2, DE 10 2013 225 874.7, DE 10 2013 225 897.6, DE 10 2013 225 873.9 and DE 10 2013 225 921.2, the contents of such applications being incorporated by reference herein.

### SUMMARY OF THE INVENTION

An aspect of the invention is an angle transmitter unit for an inductive sensor and an inductive sensor that make an absolute angle measurement within 360° achievable in a simple manner.

An aspect of the invention is based on the fundamental notion of using an additional reference resonant circuit to create a univocal reference position or univocal reference point on the angle transmitter unit. The first resonant circuit interacts with a reception coil of the sensor such that the angle of rotation is able to be sensed precisely, admittedly, but only relatively. However, this is not sufficient to univocally determine the angle of rotation in relation to one or more full revolutions. From the information of the relative angle in relation to the univocal reference position, it is possible to univocally establish the angular position over a full revolution. In this case, the advantage of the invention is particularly that the mode of action of the reference resonant circuit matches that of the first resonant circuit, and therefore the sensor requires no additional elements in order to detect the reference resonant circuit. This provides a relatively simple way of creating a reference point on the angle transmitter unit.

In order to distinguish between the first resonant circuit and the reference resonant circuit, however, it is necessary for the reference resonant circuit, in traveling over the sensor or the reception coil or reception coils, to bring about a change in the measurement that needs to be distinguished from the measurements when the reference resonant circuit does not interact with the reception coil. Therefore, it is particularly advantageous if the reference resonant circuit has only a selective action on the measurement. It is particularly advantageous if the reference resonant circuit brings about a selective and pronounced voltage amplitude on the sensor or on the reception coil. This can be achieved either by the shaping of the reference resonant circuit or the design of the individual parameters of the components of the reference resonant circuit.

The angle transmitter unit according to an aspect of the invention is advantageously developed by virtue of the first resonant circuit and the reference resonant circuit each having a natural frequency, wherein the natural frequency of the reference resonant circuit differs from that of the first resonant circuit. The reference resonant circuit can thus be distinguished from the first resonant circuit in a particularly simple manner.

The angle transmitter unit according to an aspect of the invention is advantageously developed by virtue of the first resonant circuit and the reference resonant circuit being arranged on a support body, wherein the reference resonant circuit and the first resonant circuit are arranged on the support body in a manner interleaved in one another. This ensures that the recognition of the first resonant circuit and of the reference resonant circuit works reliably. There is no need for separate adaptation of the reception coil in order to sense the reference resonant circuit. Further, this allows a particularly space-saving arrangement of the resonant circuits.

The angle transmitter unit according to an aspect of the invention is advantageously developed by virtue of the angle transmitter unit having multiple reference resonant circuits. This allows a distinction to be made for circle segments that may be advantageous to it depending on the application.

The angle transmitter unit according to an aspect of the invention is advantageously developed by virtue of at least one of the reference resonant circuits having a univocal natural frequency. This provides a simple way of ensuring that the reference resonant circuits are distinguishable from one another. Since the position of the reference resonant circuits on the angle transmitter unit does not change, it is sufficient to univocally identify one of the many reference resonant circuits in order to be able to make an inference as to the further reference resonant circuits. Reference resonant circuits having identical natural frequencies can be univocally identified in relation to the univocal reference resonant circuit on the basis of the counting of the reference resonant circuits, for example.

The angle transmitter unit according to an aspect of the invention is advantageously developed by virtue of the reference resonant circuits being arranged at uniform intervals along the trajectory of motion of the angle transmitter unit.

The angle transmitter unit according to an aspect of the invention is advantageously developed by virtue of multiple reference resonant circuits being at intervals of 45°, 90° or 180° from one another.

The angle transmitter unit according to an aspect of the invention is advantageously developed by virtue of the reference resonant circuit comprising a conductor track and a capacitor.

The angle transmitter unit according to an aspect of the invention is advantageously developed by virtue of the natural frequency of the reference resonant circuit being defined by means of the shaping of the conductor track and/or by means of the capacitance of the capacitor.

The angle transmitter unit according to an aspect of the invention is advantageously developed by virtue of the reference resonant circuit being in a form that extends essentially in a radial direction. The very narrow form of the reference resonant circuit in the circumferential direction, or the slot-like shape of said reference resonant circuit, allows the passage of the reference point or the reference resonant circuit via the reception coil to be recognized particularly distinctly. In particular, it is advantageous to design the reference resonant circuit such that the voltage peak brought about by the reference resonant circuit in the reception coil turns out particularly distinctly and recognition of the reference resonant circuit is therefore reliably possible. Alternatively, however, it is also conceivable for the reference resonant circuit to be provided in a form over a certain width along the circumference in order to recognize as early as possible whether the location is in the region of the zero crossing, for example. Depending on the application, it is therefore possible to distinguish which of these two variants is advantageous.

In addition to the features of the angle transmitter unit, a sensor that makes use of the opportunities of the angle transmitter unit is particularly advantageous.

The sensor according to an aspect of the invention is advantageously developed by virtue of an evaluation unit being in a form such that the absolute angle of the angle transmitter unit is ascertainable from the position of the first resonant circuit and of the reference resonant circuit.

The sensor according to an aspect of the invention is advantageously developed by virtue of the rotation speed of the angle transmitter unit being ascertainable by means of the evaluation unit. In this regard, it is particularly advantageous to use multiple reference resonant circuits. In particular, it is preferred for the reference resonant circuits to be arranged at a uniform interval from one another. This allows the sensor to be used as an angle sensor and at the same time as a rotation angle speed sensor.

The sensor according to the invention is advantageously developed by virtue of the reference resonant circuit being defined as a zero crossing of the angle transmitter unit.

### BRIEF DESCRIPTION OF THE DRAWINGS

Aspects of the invention are described in more detail below using figures and exemplary embodiments. In the figures:

FIG. 1 shows a schematic representation of the angle transmitter unit according to the invention, and

FIG. 2 shows a schematic representation of the sensor according to the invention.

### DETAILED DESCRIPTION OF THE PREFERRED EMBODIMENTS

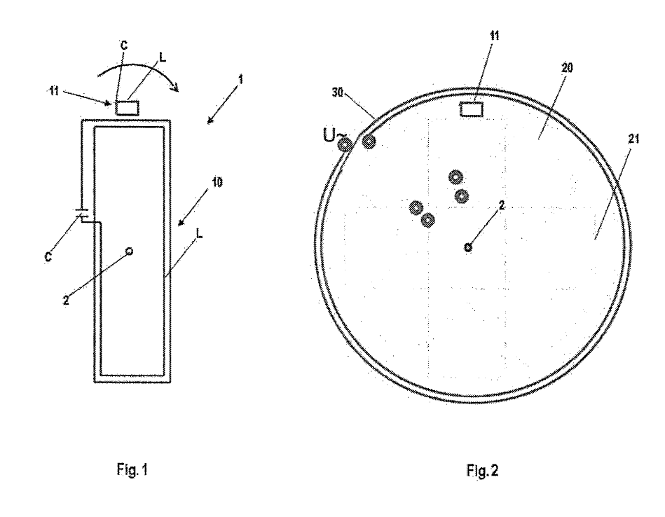

FIG. 1 shows essential parts of an angle transmitter unit 1 according to an aspect of the invention for an inductive sensor for sensing the position of a rotating element. The angle transmitter unit has a first resonant circuit 10. In addition to the first resonant circuit 10, the angle transmitter unit has at least one further univocally identifiable reference resonant circuit 11 in order to form a reference position on the angle transmitter unit. The first resonant circuit 10 and the reference resonant circuit 11 comprise a conductor track and a capacitor and form an electrical resonant circuit having an inductive and a capacitive element. The design of the first resonant circuit 10 and the design of the reference resonant circuit 11 are therefore identical, in principle.

The figures do not show the support body on which the resonant circuits 10, 11 are arranged. By way of example, the support body may be a printed circuit board on which the resonant circuits 10, 11 are printed or otherwise applied. The support body in turn may be connected to a rotating element, for example a shaft, in a different way. The design of the support body and the design of the rotating element are not essential to the invention, however, and can be matched to the requirements of the respective applications.

FIG. 2 shows a field coil 30 and two reception coils 20, 21. The field coil 30 is arranged circularly around the reception coils 20, 21 and is supplied with an AC voltage U˜. The reception coils 20, 21 are formed from a conductor track, and form multiple, essentially multiple square-shaped, sections arranged in a cross shape relative to one another. In this case, the reception coils 20, 21 are each twisted relative to one another through preferably 45° around the center 2 in order to achieve a phase shift between the output voltages of the reception coils. On account of the AC voltage U˜, an exciter field is produced around the field coil 30 and in turn induces an output voltage in each of the reception coils 20, 21. The mode of action of the sensor comprising the resonant circuits 10, 11 and the coils 20, 21, 30 is known sufficiently from the prior art and is not explained further here. Further, the angle transmitter unit 1 is also usable with other configurations of the field and reception coils 20, 21, 30.

The field and reception coils 30, 20, 21 are arranged on another, second support body that is arranged opposite the support body of the angle transmitter unit, so that the resonant circuits 10, 11 and the coils 30, 20, 21 are positioned congruently or with an overlap in relation to one another, in a manner comparable to two overlapping wafers. Ideally, the centers 2 of the two support bodies should be situated on an axis of rotation.

In order to be able to distinguish the first resonant circuit 10 from the reference resonant circuit 11 in terms of signaling, the reference resonant circuit 11 has a natural frequency that differs from that of the first resonant circuit 10. The reference resonant circuit 11 has a much smaller width than the first resonant circuit 10. The height of the reference resonant circuit 11 is also far lower than that of the first resonant circuit 10. Furthermore, the reference resonant circuit 11 is arranged at one of the head ends of the first resonant circuit 10. On account of the distinct natural frequency of the reference resonant circuit 11, the smaller dimensions with the limited extent and dimensions and the arrangement at one position, the range of action of the reference resonant circuit 11 is limited to the reception coils and can be easily identified. The reference resonant circuit produces a recognizable voltage change of the output voltage of the reception coils 20, 21 when this range slips over or travels over the reception coils 20, 21 as if the opposite head end of the first resonant circuit, where there is no reference resonant circuit, experiences via the reception coils. It is not absolutely necessary for the reference resonant circuit 11 to be arranged at a head end of the first resonant circuit. Depending on the shape of the support body of the angle transmitter unit 1, but also on the shape of the reception coils 20, 21, the reference resonant circuit 11 may be arranged at another position, where it can interact with the reception coils 20, 21. By way of example, it is sufficient for the reference resonant circuit 11 to be positioned such that it approximately cuts across the edge region of the reception coils 20, 21, as represented by way of example in FIG. 2.

It is conceivable for the first resonant circuit 10 and the reference resonant circuit 11 to be arranged in a manner interleaved in one another. In this case, such an arrangement can be made dependent on the design of the reception coils. Furthermore, it is advantageous for the reference resonant circuit to be made in a slot-like form, so that it extends essentially in a radial direction. A further configuration—not shown here—of the angle transmitter unit provides for multiple reference resonant circuits. Preferably, at least one of the reference resonant circuits should have a univocal natural frequency that differs from those of the other reference resonant circuits. This can be accomplished by a different shaping of the conductor track or by a different choice of the capacitor, for example. In this context, the reference resonant circuits may be arranged at uniform intervals along the trajectory of motion, along a circumferential line, of the angle transmitter unit. An interval of 45°, 90° or 180° between the reference resonant circuits is advantageous.

The voltage changes or differences that the reference resonant circuits produce in the output voltages can be used by an evaluation unit to firmly reference the relative angle of the first resonant circuit to at least one reference point. From the information of the relative angle in relation to the reference point, it is possible to ascertain the absolute angle of the angle transmitter unit. This can be achieved in a particularly simple manner if the evaluation unit is configured such that a reference resonant circuit is defined as a zero crossing or zero point. Further, it is possible for the rotation speed of the angle transmitter unit to be ascertainable by means of the evaluation unit by virtue of the intervals of time between two measurements of reference points being measured. The speed to be measured is all the more accurate the more reference resonant circuits there are and the shorter the intervals of time between the measurements of the reference points become.

1. An angle transmitter unit for an inductive sensor for sensing a position of a rotating element, wherein the angle transmitter unit is connectable to a rotating element and has at least one first resonant circuit that interacts with at least one receiver coil of the sensor in order to prescribe the angle of the rotating element, wherein the angle transmitter unit has, in addition to the first resonant circuit, at least one further univocally identifiable reference resonant circuit in order to form a reference position on the angle transmitter unit.

2. The angle transmitter unit as claimed in claim 1, wherein the first resonant circuit and the reference resonant circuit each have a natural frequency, wherein the natural frequency of the reference resonant circuit differs from that of the first resonant circuit.

3. The angle transmitter unit as claimed in claim 1, wherein the first resonant circuit and the reference resonant circuit are arranged on a support body, wherein the reference resonant circuit and the first resonant circuit are arranged on the support body in a manner interleaved in one another.

4. The angle transmitter unit as claimed in claim 1, wherein the angle transmitter unit has multiple reference resonant circuits.

5. The angle transmitter unit as claimed in claim 4, wherein at least one of the reference resonant circuits has a univocal natural frequency.

6. The angle transmitter unit as claimed in claim 1, wherein the reference resonant circuits are arranged at uniform intervals along a trajectory of motion of the angle transmitter unit.

7. The angle transmitter unit as claimed in claim 6, wherein multiple reference resonant circuits are at intervals of 45°, 90° or 180° from one another.

8. The angle transmitter unit as claimed in claim 1, wherein the reference resonant circuit comprises a conductor track and a capacitor.

9. The angle transmitter unit as claimed in claim 8, wherein the natural frequency of the reference resonant circuit is defined by the shaping of the conductor track and/or by the capacitance of the capacitor.

10. The angle transmitter unit as claimed in claim 1, wherein the reference resonant circuit is in a form that extends essentially in a radial direction.

11. A sensor for sensing the position of a rotating element, comprising:
a field coil that is supplied with an AC voltage in order to generate an exciter field corresponding to the AC voltage,
at least one reception coil that is coupled to the field coil such that the exciter field induces a respective voltage in the reception coil, and
an angle transmitter unit as claimed in claim 1.

12. The sensor as claimed in claim 10, further comprising an evaluation unit, wherein the evaluation unit is in a form such that an absolute angle of the angle transmitter unit is ascertainable from the position of the first resonant circuit and of the reference resonant circuit.

13. The sensor as claimed in claim 10, wherein rotation speed of the angle transmitter unit is ascertainable by evaluation unit.

14. The sensor as claimed in claim 9, wherein the reference resonant circuit is defined as a zero crossing of the angle transmitter unit.

15. The angle transmitter unit as claimed in claim 2, wherein the first resonant circuit and the reference resonant circuit are arranged on a support body, wherein the reference resonant circuit and the first resonant circuit are arranged on the support body in a manner interleaved in one another.

16. The sensor as claimed in claim 11, wherein a rotation speed of the angle transmitter unit is ascertainable by the evaluation unit.

17. The sensor as claimed in claim 10, wherein the reference resonant circuit is defined as a zero crossing of the angle transmitter unit.

18. The sensor as claimed in claim 11, wherein the reference resonant circuit is defined as a zero crossing of the angle transmitter unit.
